(19) United States
(12) Patent Application Publication
(10) Pub. No.: US 2006/0002710 A1
(43) Pub. Date: Jan. 5, 2006

(54) Application-specific microcode for controlling an optical transceiver

(75) Inventors: Gerald L. Dybsetter, Scotts Valley, CA (US); Jayne C. Hahin, Cupertino, CA (US); Luke M. Ekkizology, San Jose, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Finisar Corporation, Sunnyvale, CA (US)

(21) Appl. No.: 11/114,984

(22) Filed: Apr. 26, 2005

Related U.S. Application Data
(60) Provisional application No. 60/584,747, filed on Jun. 30, 2004.

(51) Int. Cl. H04B 10/00

(52) U.S. Cl. 398/135

(57) ABSTRACT

A method for an optical transceiver (or transmitter or receiver) to change from a first set of functionality to a second set of functionality that is different than the first set of functionality. The optical transceiver has at least one processor and a system memory. The optical transceiver has access to a persistent memory. The persistent memory includes microcode that when loaded into system memory and executed by the processor, causes the optical transceiver to have access to a first set of functionality. In order to implement the method, second microcode in the persistent memory is made accessible to the optical transceiver. The second microcode includes one or more functions in the second set of functionality that are not included in the first set of functionality. Then, the second microcode is loaded in the system memory from the persistent memory and executed to implement the second set of functionality.

### CROSS-REFERENCE TO RELATED APPLICATIONS

This application claims the benefit of U.S. Provisional Application No. 60/584,747, filed Jun. 30, 2004, which is incorporated herein by reference in its entirety.

### BACKGROUND OF THE INVENTION

1. The Field of the Invention

The present invention relates generally to optical transmitters and receivers. More specifically, the present invention relates to optical transmitter and receivers that are capable of running different versions of microcode to manage its operation.

2. Background and Relevant Art

Computing and networking technology have transformed our world. As the amount of information communicated over networks has increased, high speed transmission has become ever more critical. Many high speed data transmission networks rely on optical transceivers and similar devices for facilitating transmission and reception of digital data embodied in the form of optical signals over optical fibers. Optical networks are thus found in a wide variety of high speed applications ranging from as modest as a small Local Area Network (LAN) to as grandiose as the backbone of the Internet.

Typically, data transmission in such networks is implemented by way of an optical transmitter (also referred to as an electro-optic transducer), such as a laser or Light Emitting Diode (LED). The electro-optic transducer emits light when current is passed through it, the intensity of the emitted light being a function of the current magnitude. Data reception is generally implemented by way of an optical receiver (also referred to as an optoelectronic transducer), an example of which is a photodiode. The optoelectronic transducer receives light and generates a current, the magnitude of the generated current being a function of the intensity of the received light.

Various other components are also employed by the optical transceiver to aid in the control of the optical transmit and receive components, as well as the processing of various data and other signals. For example, such optical transceivers typically include a driver (e.g., referred to as a “laser driver” when used to drive a laser) configured to control the operation of the optical transmitter in response to various control inputs. The optical transceiver also generally includes an amplifier (e.g., often referred to as a “post-amplifier”) configured to amplify the channel-attenuated received signal prior to further processing. A controller circuit (hereinafter referred to the “controller”) controls the operation of the laser driver and post-amplifier.

Controllers are typically implemented in hardware as state machines. Their operation is fast, but inflexible. Being primarily state machines, the functionality of the controller is limited to the hardware structure of the controller. What would be advantageous are controllers that have more flexible functionality.

### BRIEF SUMMARY OF THE INVENTION

The foregoing problems with the prior state of the art are overcome by the principles of the present invention, which relate to an optical transceiver (or optical transmitter or optical receiver) that has at least one processor and a system memory. The optical transceiver has access to a persistent memory, which may be an on-transceiver persistent memory or may be an off-transceiver persistent memory. The persistent memory includes microcode (also referred to as “first microcode) that when loaded into system memory and executed by the at least one processor, causes the optical transceiver to have access to a first set of functionality.

The principles of the present invention relate to a method for the optical transceiver to change from the first set of functionality to a second set of functionality that is different than the first set of functionality. Specifically, second microcode in the persistent memory is made accessible to the optical transceiver. The second microcode includes one or more functions in the second set of functionality that are not included in the first set of functionality. Then, the second microcode is loaded in the system memory from the persistent memory. The second microcode is then executed to allow the optical transceiver to implement the second set of functionality.

Accordingly, in order to change the functionality of the optical transceiver, the hardware of the optical transceiver need not change at all. Instead, different microcode is written to the persistent memory to implement the change in functionality. Loading different microcode into persistent memory is significantly more straightforward for a user than purchasing and setting up a different optical transceiver. Therefore, the principles of the present invention allow for more flexible operation for the optical transceiver at a greater convenience for the user.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 schematically illustrates an example of an optical transceiver that may implement features of the present invention;

FIG. 2 schematically illustrates an example of the control module of FIG. 1; and

FIG. 3 illustrates a flowchart of a method for changing the functionality of the optical transceiver of FIG. 1 in accordance with the principles of the present invention.

### DETAILED DESCRIPTION OF THE PREFERRED EMBODIMENTS

The principles of the present invention relate to an optical transceiver (or optical transmitter or optical receiver) that has at least one processor and a system memory. The optical transceiver has access to a persistent memory, which may be an on-transceiver persistent memory or may be an off-transceiver persistent memory. The persistent memory includes microcode (also referred to as “first microcode”) that when loaded into system memory and executed by the at least one processor, causes the optical transceiver to have access to a first set of functionality. The principles of the present invention relate to a method for the optical transceiver to change from the first set of functionality to a second set of functionality that is different than the first set of functionality. Specifically, second microcode in the persistent memory is made accessible to the optical transceiver. The second microcode includes one or more functions in the second set of functionality that are not included in the first set of functionality. Then, the second microcode is loaded in the system memory from the persistent memory. The second microcode is then executed to allow the optical transceiver to implement the second set of functionality.

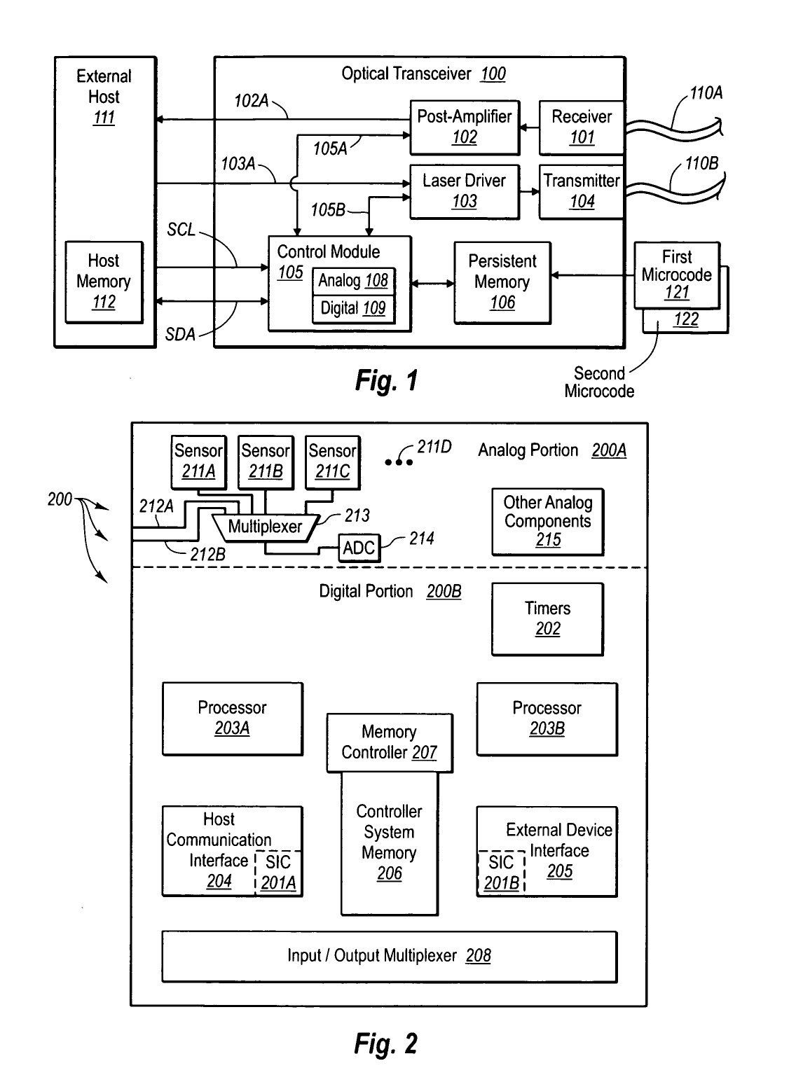

FIG. 1 illustrates an optical transceiver 100 in which the principles of the present invention may be employed. While the optical transceiver 100 will be described in some detail, the optical transceiver 100 is described by way of illustration only, and not by way of restricting the scope of the invention. The principles of the present invention are suitable for 1G, 2G, 4G, 8G, 10G and higher bandwidth fiber optic links. Furthermore, the principles of the present invention may be implemented in optical (e.g., laser) transmitter/receivers of any form factor such as XFP, SFP and SFF, without restriction. Having said this, the principles of the present invention are not limited to an optical transceiver environment at all.

The optical transceiver 100 receives an optical signal from fiber 110A using receiver 101. The receiver 101 acts as an opto-electric transducer by transforming the optical signal into an electrical signal. The receiver 101 provides the resulting electrical signal to a post-amplifier 102. The post-amplifier 102 amplifies the signal and provides the amplified signal to an external host 111 as represented by arrow 102A. The external host 111 may be any computing system capable of communicating with the optical transceiver 100. The external host 111 may contain a host memory 112 that may be a volatile or non-volatile memory source. In one embodiment, the optical transceiver 100 may be a printed circuit board or other components/chips within the host 111, although this is not required.

The optical transceiver 100 may also receive electrical signals from the host 111 for transmission onto the fiber 110B. Specifically, the laser driver 103 receives the electrical signal as represented by the arrow 103A, and drives the transmitter 104 (e.g., a laser or Light Emitting Diode (LED)) with signals that cause the transmitter 104 to emit onto the fiber 110B optical signals representative of the information in the electrical signal provided by the host 111. Accordingly, the transmitter 104 serves as an electro-optic transducer.

The behavior of the receiver 101, the post-amplifier 102, the laser driver 103, and the transmitter 104 may vary dynamically due to a number of factors. For example, temperature changes, power fluctuations, and feedback conditions may each affect the performance of these components. Accordingly, the optical transceiver 100 includes a control module 105, which may evaluate temperature and voltage conditions and other operational circumstances, and receive information from the post-amplifier 102 (as represented by arrow 105A) and from the laser driver 103 (as represented by arrow 105B). This allows the control module 105 to optimize the dynamically varying performance, and additionally detect when there is a loss of signal.

Specifically, the control module 105 may counteract these changes by adjusting settings on the post-amplifier 102 and/or the laser driver 103 as also represented by the arrows 105A and 105B. These settings adjustments are quite intermittent since they are only made when temperature or voltage or other low frequency changes so warrant. Receive power is an example of such a low frequency change.

The control module 105 may have access to a persistent memory 106, which in one embodiment, is an Electrically Erasable and Programmable Read Only Memory (EEPROM). The persistent memory 106 and the control module 105 may be packaged together in the same package or in different packages without restriction. Persistent memory 106 may also be any other non-volatile memory source.

The control module 105 includes both an analog portion 108 and a digital portion 109. Together, they allow the control module to implement logic digitally, while still largely interfacing with the rest of the optical transceiver 100 using analog signals. FIG. 2 schematically illustrates an example 200 of the control module 105 in further detail. The control module 200 includes an analog portion 200A that represents an example of the analog portion 108 of FIG. 1, and a digital portion 200B that represents an example of the digital portion 109 of FIG. 1.

For example, the analog portion 200A may contain digital to analog converters, analog to digital converters, high speed comparators (e.g., for event detection), voltage based reset generators, voltage regulators, voltage references, clock generator, and other analog components. For example, the analog portion 200A includes sensors 211A, 211B, 211C amongst potentially others as represented by the horizontal ellipses 211D. Each of these sensors may be responsible for measuring operational parameters that may be measured from the control module 200 such as, for example, supply voltage and transceiver temperature. The control module may also receive external analog or digital signals from other components within the optical transceiver that indicate other measured parameters such as, for example, laser bias current, transmit power, receive power, laser wavelength, laser temperature, and Thermo Electric Cooler (TEC) current. Two external lines 212A and 212B are illustrated for receiving such external analog signals although there may be many of such lines.

The internal sensors may generate analog signals that represent the measured values. In addition, the externally provided signals may also be analog signals. In this case, the analog signals are converted to digital signals so as to be available to the digital portion 200B of the control module 200 for further processing. Of course, each analog parameter value may have its own Analog to Digital Converter (ADC). However, to preserve chip space, each signal may be periodically sampled in a round robin fashion using a single ADC such as the illustrated ADC 214. In this case, each analog value may be provided to a multiplexer 213, which selects in a round robin fashion, one of the analog signals at a time for sampling by the ADC 214. Alternatively, multiplexer 213 may be programmed to allow any order of analog signals to be sampled by ADC 214.

As previously mentioned, the analog portion 200A of the control module 200 may also include other analog components 215 such as, for example, digital to analog converters, other analog to digital converters, high speed comparators (e.g., for event detection), voltage based reset generators, voltage regulators, voltage references, clock generator, and other analog components. The digital portion 200B of the control module 200 may include a timer module 202 that provides various timing signals used by the digital portion 200B. Such timing signals may include, for example, programmable processor clock signals. The timer module 202 may also act as a watchdog timer.

Two general-purpose processors 203A and 203B are also included. The processors recognize instructions that follow a particular instruction set, and may perform normal general-purpose operation such as shifting, branching, adding, subtracting, multiplying, dividing, Boolean operations, comparison operations, and the like. In one embodiment, the general-purpose processors 203A and 203B are each a 16-bit processor and may be identically structured. The precise structure of the instruction set is not important to the principles of the present invention as the instruction set may be optimized around a particular hardware environment, and as the precise hardware environment is not important to the principles of the present invention.

A host communications interface 204 is used to communicate with the host 111 possibly implemented using a two-wire interface such as I²C shown in FIG. 1 as the serial data (SDA) and serial clock (SCL) lines on the optical transceiver 100. Other host communication interfaces may also be implemented as well. Data may be provided from the control module 105 to the host 111 using this host communications interface to allow for digital diagnostics and readings of temperature levels, transmit/receiver power levels, and the like. The external device interface 205 is used to communicate with, for example, other modules within the optical transceiver 100 such as, for example, the post-amplifier 102, the laser driver 103, or the persistent memory 106.

The internal controller system memory 206 (not to be confused with the external persistent memory 106) may be Random Access Memory (RAM) or non-volatile memory. The memory controller 207 shares access to the controller system memory 206 amongst each of the processors 203A and 203B and with the host communication interface 204 and the external device interface 205. In one embodiment, the host communication interface 204 includes a serial interface controller 201A, and the external device interface 205 includes a serial interface controller 201B. The two serial interface controllers 201A and 201B may communicate using a two-wire interface such as I²C or may be another interface so long as the interface is recognized by both communicating modules. One serial interface controller (e.g., serial interface controller 201B) is a master component, while the other serial interface controller (e.g., serial interface controller 201A) is a slave component.

An input/output multiplexer 208 multiplexes the various input/output pins of the control module 200 to the various components within the control module 200. This enables different components to dynamically assign pins in accordance with the then-existing operational circumstances of the control module 200. Accordingly, there may be more inputoutput nodes within the control module 200 than there are pins available on the control module 200, thereby reducing the footprint of the control module 200.

Having described a specific environment with respect to FIGS. 1 and 2, it will be understood that this specific environment is only one of countless architectures in which the principles of the present invention may be employed. As previously stated, the principles of the present invention are not intended to be limited to any particular environment.

Referring to FIG. 1, the persistent memory 106 may include first microcode that when loaded in controller system memory 206 and executed by one or both of the processors 203 causes the optical transceiver to have access to a first set of functionality. It should be noted that the optical transceiver 100 need not include a persistent memory 106 for the principles of the present invention to be enabled. The optical transceiver 100 may instead have access to other persistent memory sources such a host computing system persistent memory or a remote persistent memory coupled to transceiver 100 over a network such as the Internet. It may even be possible for transceiver 100 to access both an on-transceiver persistent memory such as memory 106 and another persistent memory. In the description and in the claims, “persistent memory” is defined to mean any persistent memory that the optical transceiver may access, including both on-transceiver and off-transceiver persistent memories. In accordance with the principles of the present invention, the optical transceiver may change from the first set of functionality to a second set of functionality that is different than the first set of functionality. For instance, second microcode 122 may be configured for the second set of functionality.

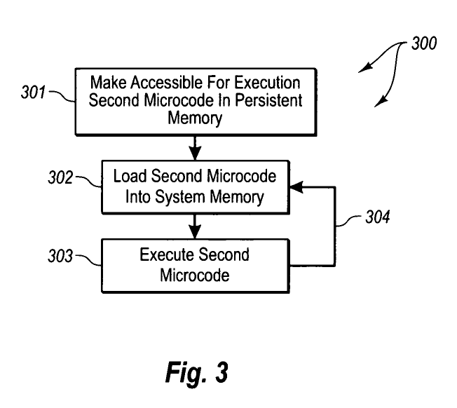

FIG. 3 illustrates a flowchart of a method 300 for changing functionality in accordance with the principles of the present invention. The method 300 begins in a state in which only the first microcode 121 in the persistent memory 106 or other accessible persistent memory source is accessible for execution. Then, referring to the method 300, second microcode in the persistent memory is made accessible for execution (act 301). The second microcode 122 is made accessible for execution by either writing it to the persistent memory or by making microcode already stored in the persistent memory accessible. The second microcode 122 includes one or more functions in a second set of functionality that are not included in the first set of functionality enabled by the first microcode 121.

The second microcode is the loaded from persistent memory to system memory (act 302) for execution by the processor(s) (act 303). For example, the second microcode 122 may be loaded from the persistent memory 106 into the controller system memory 206 for execution by the one or more processors 203. Alternatively, the second microcode 122 may be loaded from an off-transceiver persistent memory into the controller system memory 206 for execution by the one or more processors 203. In one embodiment in which the microcode is executed directly by the processors from persistent memory, the microcode may be loaded one fragment at a time (e.g., one instruction at a time) into a smaller system memory such as for example a processor register, flip-flops, or the like. Accordingly, the loading and executing operations may be repeatedly performed for each fragment as represented by arrow 304.

When making accessible for execution the second microcode 122 in the persistent memory, the entire first microcode 121 may be overwritten. In that case, the second microcode includes all the microcode needed to cause the optical transceiver to implement the second set of functionality when executed by the processor(s). Alternatively, the second microcode 122 may overwrite only some of the first microcode 121, but leave a remaining portion of the first microcode 121. In that case, the second microcode in combination with the remaining portion of the first microcode contains sufficient microcode to cause the optical transceiver to implement the second set of functionality when executed by the processor(s). Finally, the entire first microcode 121 may be preserved when writing the second microcode 122 into the persistent memory 106. In that final case, the second microcode 122 in combination with the first microcode 121 contains sufficient microcode to cause the optical transceiver to implement the second set of functionality when executed by the processor(s).

The second microcode may be drafted in any manner so as to implement the second set of functionality. For example, the second set of functionality may facilitate data transfer at higher data rates than enabled by the first set of functionality, may add the ability to perform digital diagnostics, may follow a protocol not followed by the first set of functionality, may supports a protocol for communicating with a host that is not supported by the first set of functionality, may support off-module logging whereas the first set of functionality does not, may support calibration whereas the first set of functionality does not, may support temperature compensation for a different range of temperatures as compared to the first set of functionality, may support operations for a different range of receive power as compared to the first set of functionality, may support end-of-life operation whereas the first set of functionality does not, may support custom logging operations whereas the first set of functionality does not, may log different parameters than the first set of functionality, may supports trimming whereas the first set of functionality does not.

Accordingly, the principles of the present invention allow for the entire behavioral characteristics to be conveniently changed for the entire transceiver without replacing the transceiver, and without requiring excessive human intervention. Simple access to the second microcode and the ability to load the second microcode into the persistent memory is enough. The microcode may be changed a number of times over the lifetime of the optical transceiver as is appropriate given changing circumstances.

The second microcode 122 may have been obtained by the optical transceiver 100 in any manner. For example, the second microcode 122 may be obtained from the host computing system 111. The host computing system 111 may obtain the second microcode over a network such as a local area network or the Internet, for example. The host computing system 111 may contain a library of microcode that may be provided to the optical transceiver 100.

Therefore, the principles of the present invention allows for a convenient way to change the functionality of an optical transceiver through the use of microcode. By using microcode, the functionality of the optical transceiver may be changed without having to change the hardware structure of the transceiver. The principles of the present invention may also be applied to an optical receiver without an optical transmitter, or to an optical transmitter without an optical receiver. Accordingly, the principles of the present invention are not limited to the optical transceiver environment and represent a significant advancement in the arts of optical transceivers, transmitters, and receivers.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed and desired secured by united states Letters Patent is:

1. In an optical transceiver that includes at least one processor and a system memory, the optical transceiver having access to a persistent memory, wherein the persistent memory includes first microcode that when loaded into system memory and executed by the at least one processor, causes the optical transceiver to have access to a first set of functionality, a method for the optical transceiver to change from the first set of functionality to a second set of functionality that is different than the first set of functionality, the method comprising the following:
an act of making accessible for execution second microcode in the persistent memory, the second microcode including one or more functions in the second set of functionality that are not included in the first set of functionality;
an act of loading the second microcode from the persistent memory into the system memory of the optical transceiver; and
an act of the at least one processor of the optical transceiver executing the second microcode.

2. A method in accordance with claim 1, wherein the act of making accessible for execution the second microcode in the persistent memory includes an act of overwriting all of the first microcode, wherein the second microcode includes all the microcode needed to cause the optical transceiver to implement the second set of functionality when executed by the at least one processor.

3. A method in accordance with claim 1, wherein the act of making accessible for execution the second microcode in the persistent memory includes an act of overwriting some of the first microcode but leaving a remaining portion of the first microcode, wherein the remaining portion of the first microcode and the second microcode in combination cause the optical transceiver to implement the second set of functionality when executed by the at least one processor.

4. A method in accordance with claim 1, wherein the act of making accessible for execution the second microcode in the persistent memory includes an act of preserving all of the first microcode in persistent memory, wherein the first and second microcode in combination cause the optical transceiver to implement the second set of functionality when executed by the at least one processor.

5. A method in accordance with claim 1, wherein the second set of functionality facilitates data transfer at higher data rates than enabled by the first set of functionality.

6. A method in accordance with claim 1, wherein the first set of functionality does not include the ability to perform digital diagnostics, whereas the second set of functionality does include the ability to perform digital diagnostics.

7. A method in accordance with claim 1, wherein the second set of functionality follows a protocol not followed by the first set of functionality.

8. A method in accordance with claim 1, wherein the second set of functionality supports a protocol for communicating with a host that is not supported by the first set of functionality.

9. A method in accordance with claim, 1, wherein the second set of functionality supports off-module logging, whereas the first set of functionality does not.

10. A method in accordance with claim 1, wherein the second set of functionality supports calibration, whereas the first set of functionality does not.

11. A method in accordance with claim 1, wherein the second set of functionality supports a temperature compensation for a different range of temperatures as compared to the first set of functionality.

12. A method in accordance with claim 1, wherein the second set of functionality supports operations for a different range of receive power as compared to the first set of functionality.

13. A method in accordance with claim 1, wherein the second set of functionality supports end-of-life operations, whereas the first set of functionality does not.

14. A method in accordance with claim 1, wherein the second set of functionality supports custom logging operations, whereas the first set of functionality does not.

15. A method in accordance with claim 1, wherein the second set of functionality logs different parameters than the first set of functionality.

16. A method in accordance with claim 1, wherein the second set of functionality supports trimming, whereas the first set of functionality does not.

17. A method in accordance with claim 1, wherein the second microcode is obtained from a host computing system coupled to the optical transceiver.

18. A method in accordance with claim 1, wherein the second microcode is obtained by the host computing system over a network.

19. A method in accordance with claim 1, wherein the second microcode is obtained by the host computing system over the Internet.

20. A method in accordance with claim 1, wherein the optical transceiver has access to one of an on-transceiver persistent memory or an off-transceiver persistent memory.

21. In an optical transmitter that includes at least one processor and a system memory, the optical transmitter having access to a persistent memory, wherein the persistent memory includes first microcode that when loaded into system memory and executed by the at least one processor, causes the optical transmitter to have access to a first set of functionality, a method for the optical transmitter to change from the first set of functionality to a second set of functionality that is different than the first set of functionality, the method comprising the following:
an act of making accessible for execution second microcode in the persistent memory, the second microcode including one or more functions in the second set of functionality that are not included in the first set of functionality;
an act of loading the second microcode from the persistent memory into the system memory of the optical transmitter; and
an act of the at least one processor of the optical transmitter executing the second microcode.

22. In an optical receiver that includes at least one processor and a system memory, the optical receiver having access to a persistent memory, wherein the persistent memory includes first microcode that when loaded into system memory and executed by the at least one processor, causes the optical receiver to have access to a first set of functionality, a method for the optical receiver to change from the first set of functionality to a second set of functionality that is different than the first set of functionality, the method comprising the following:
an act of making accessible for execution second microcode in the persistent memory, the second microcode including one or more functions in the second set of functionality that are not included in the first set of functionality;
an act of loading the second microcode from the persistent memory of the optical receiver into the system memory of the optical receiver; and
an act of the at least one processor of the optical receiver executing the second microcode.
